(19) United States
(12) Patent Application Publication
(10) Pub. No.: US 2025/0361091 A1
(43) Pub. Date: Nov. 27, 2025

(54) Trolley Single Point Adjustment System

(71) Applicant: Columbus McKinnon Corporation, Getzville, NY (US)

(72) Inventors: Brad Grubb, Bristol, TN (US); Brian Karns, Belmont, NC (US); Marc Lewis, Bristol, VA (US)

(21) Appl. No.: 18/672,720

(22) Filed: May 23, 2024

(51) Int. Cl. B65G 17/20

(52) U.S. Cl. CPC B65G 17/20

(57) ABSTRACT

A beam trolley has a system that provides for adjustment of the width without removing the side plates. A load bar with right hand threads on one side and left hand threads on the other side is installed in threaded openings in side plates. A load plate with an anti-rotation profile in a midportion supports an underhung hoist. The load plate engages with the load bar such that in a first configuration the load bar is prevented from rotating relative to the load plate and in a second configuration the load bar may rotate freely with respect to the load plate. In another embodiment, a pair of load bars are used in connection with an elongate rod for adjusting the side plates. The pair of load bars provides for increased headroom for the hoist.

### TECHNICAL FIELD

The present invention relates generally to the field of material handling equipment, and more particularly to a system for use with a beam trolley for supporting a hoist and a method of using such a system.

### BACKGROUND ART

One of the most common trolley designs for hoists uses two side frames, two load suspension pins with threaded ends, a set of flat washers or spacers, and threaded nuts. The process for adjusting the trolley for a particular beam flange requires: removing the nuts, spacers and both side frames; installing washers in the appropriate areas to achieve the desired spacing; and reinstalling the other components.

### BRIEF SUMMARY OF THE INVENTION

With parenthetical reference to the corresponding parts, portions or surfaces of the disclosed embodiment, merely for the purposes of illustration and not by way of limitation, the present invention provides a trolley (10) for use on a beam (13). The trolley (10) has a width adjustment system. The trolley (10) includes a first side plate (16) having two or more wheels disposed thereon. The first side plate (16) is configured to couple with the beam (13). The first side plate (16) has an opening (28) with threads disposed therein.

A second side plate (19) has two or more wheels disposed thereon. The second side plate (19) is configured to couple with the beam (13). The second side plate (19) has an opening (34) with threads disposed therein.

A load bar (40) has a first end (43) disposed opposite from a second end (46). The load bar (40) has right hand threads (49) extending in the longitudinal direction toward the first end (43) and the load bar (40) has left hand threads extending in the longitudinal direction toward the second end (46). The load bar (40) has an anti-rotation profile (58) in cross-section along a midportion (55) between the right hand threads (49) and left hand threads.

A load plate (61) has an opening (76) defined therein. The opening (76) has a first portion (79) defining an anti-rotation keyway (85) configured to receive the anti-rotation profile (58) on the load bar (40) to prevent relative rotation between the load bar (40) and the load plate (61). The opening (76) has a second portion (82) that is larger than the first portion (79) such that when the load bar (40) is positioned in the second portion (82), the load bar (40) is able to rotate independently of the load plate (61).

Rotation of the load bar (40) in a first direction while the load bar (40) is disposed in the second portion (82) of the opening (76) in the load plate (61) and the side plates (16, 19) are prevented from rotating (but allowed translatory motion) causes the first side plate (16) and the second side plate (19) to move toward each other to adjust the width of the trolley (10).

In another aspect, the load plate (61) has a second opening (83) configured to receive a pin (86).

In another aspect the first and second side plates (16, 19) have second openings (31, 37) configured to receive the pin (86).

In yet another aspect, the pin (86) extends through the second opening (31) in the first plate (16) and the second opening (83) in the load plate (61).

In another aspect of the invention, the pin (86) extends through the second opening (31) in the first plate (16), the second opening (37) in the second plate (19), and the second opening (83) in the load plate (61).

Another aspect of the invention includes a jam nut (52) disposed on the load bar (40).

In another aspect of the invention, the first portion (79) of the opening (76) in the load plate (61) is disposed above the second portion (82) of the opening (76) in the load plate (61).

In another embodiment of the invention, a second portion (97) of an opening (91) in a load plate (88) is offset laterally from a first portion (94) of the opening (91) in the load plate (88).

In another embodiment of the invention, a second portion (139) of an opening (133) in a load plate (109) extends lengthwise through a side of the load plate (109) to form an open slot (112) at the end.

In a further aspect, a removable plate (106) is configured to attach to the load plate (109) to close the open slot (112) at the side of the load plate (109).

In another embodiment a load plate (200) has an opening (203) defined therein. The opening (203) has a bearing (206) disposed therein. The bearing (206) is operatively associated with the load bar (40) such that in a first configuration the load bar (40) rotates freely relative to the load plate (200) and in a second configuration the load bar (40) is prevented from rotating relative to the load plate (200).

Rotation of the load bar (40) in a first direction while the side plates (16, 19) are prevented from rotating (but allowed translatory motion) causes the first side plate (16) and the second side plate (19) to move toward each other to adjust the width of the trolley (10).

In another embodiment, the present invention provides a trolley (300) for use on a beam (13). The trolley (300) has a width adjustment system. The trolley (300) includes a first side plate (303) having two or more wheels (17). The first side plate (303) is configured to couple with the beam (10). The first side plate (303) has an opening (350) with threads disposed therein. A second side plate (306) has two or more wheels (17) disposed thereon. The second side plate (306) is configured to couple with the beam (10). The second side plate (306) has an opening (353) with threads disposed therein.

An elongate rod (340) has a first end disposed opposite from a second end. The elongate rod (340) has right hand threads (343) extending in the longitudinal direction toward the first end and left hand threads (346) extending in the longitudinal direction toward the second end.

A pair of load bars (321, 324) extend between the side plates (303, 306) and are supported therefrom.

A load plate (309) has a pair of openings (312, 315) defined therein. The openings (312, 315) are configured to receive the load bars (321, 324). The load plate (309) has a third opening (318) for receiving the elongate rod (340).

Rotation of the elongate rod (340) in a first direction while the side plates (303, 306) are prevented from rotating causes the first side plate (303) and the second side plate (306) to move toward each other to adjust the width of the trolley (300).

### BRIEF DESCRIPTION OF THE DRAWINGS

FIG. 1 is a perspective view of a trolley, with the adjustment system of the present invention, mounted on an I-beam and supporting a hoist.

FIG. 2. is a perspective view of a first embodiment of the trolley single point adjustment system of the present invention.

FIG. 3 is a cross-sectional view of the system show in FIG. 2.

FIG. 4 is a perspective view of a second embodiment of the trolley single point adjustment system of the present invention.

FIG. 5 is a cross-sectional view of the system shown in FIG. 4.

FIG. 6 is a another cross-section view of the system shown in FIG. 4.

FIG. 7 is a perspective exploded view of an alternate construction for the embodiment shown in FIG. 4.

FIG. 8 is a perspective view of the system shown in FIG. 7 with the removable plate installed on the load plate.

FIG. 9 is a perspective view of a third embodiment of the trolley single point adjustment system of the present invention

FIG. 10 is a perspective view of a fourth embodiment of the trolley single point adjustment system of the present invention.

FIG. 11 is another perspective view of the trolley single point adjustment system shown in FIG. 10.

FIG. 12 is another perspective view of the trolley single point adjustment system shown in FIG. 10.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, debris, etc.) together with the specification, and are to be considered a portion of the entire written description of this invention. As used in the following description, the terms “horizontal”, “vertical”, “left”, “right”, “up” and “down”, as well as adjectival and adverbial derivatives thereof, (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or of rotation, as appropriate.

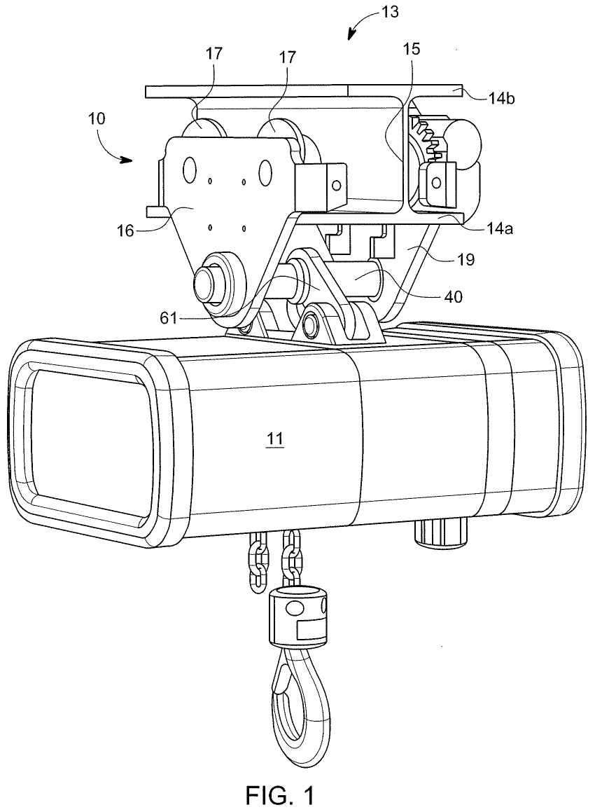

Referring now to the drawings, and more particularly to FIG. 1 thereof, this invention provides a trolley 10 for an underhung hoist 11 supported from a beam 13 such as an I-beam with a pair of horizontal flanges 14A, 14B connected by a vertical web 15. The trolley 10 has a first side plate 16 and a second side plate 19. The first side plate 16 has one or more wheels 17 that may be configured to ride along the lower flange 14A of the beam 13. The second side plate 19 also has one or more wheels that may be configured to ride along the lower flange 14A of the beam 13 on the opposite side of the web 15 of the beam 13.

In order to use the trolley 10 with beams 13 having different dimensions, the trolley 10 is adjustable such that the first side plate 16 and second side plate 19 can be moved toward or away from each other to adjust the width of the trolley 10 to accommodate the different beam widths.

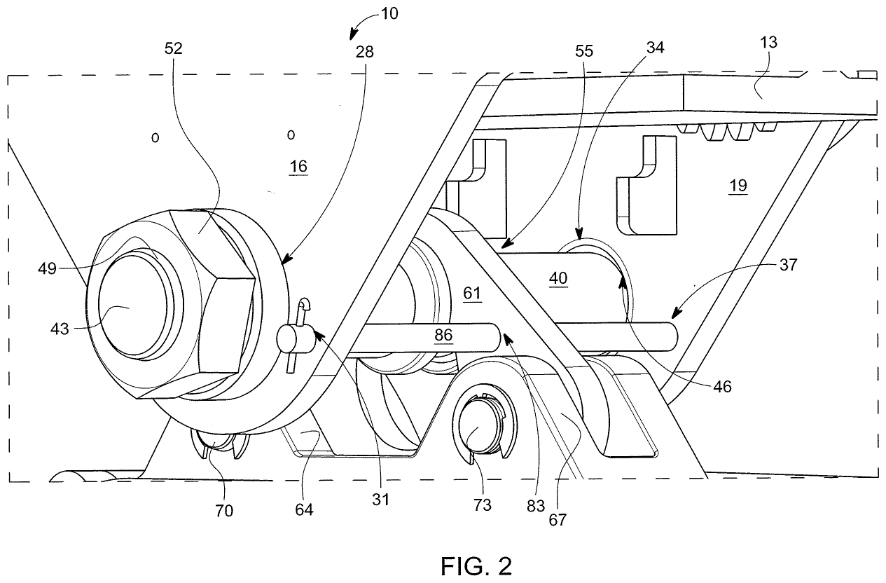

Turning to FIG. 2, the first side plate 16 has an opening 28 defined therein. The opening 28 has a set of internal threads. The first side plate 16 may also be provided with a second opening 31 defined therein.

The second side plate 19 has an opening 34 defined therein. The opening 34 has a set of internal threads. The second side plate 19 may also be provided with a second opening 37 defined therein.

A load bar 40 extends between the first side plate 16 and the second side plate 19. The load bar 40 has a first end 43 and a second end 46 disposed opposite from the first end 43. A set of right hand threads 49 may extend to the first end 43 of the load bar 40. A jam nut 52 may be disposed adjacent to the first end 43 to pre-load the threads to improve stresses and to generally tighten the assembly. A set of left hand threads may extend to the second end 46 of the load bar 40. The threaded ends of the load bar 40 are threaded into the threaded openings 28 and 34 in the first side plate 16 and second side plate 19, respectively.

In a mid-portion 55 of the load bar 40, an anti-rotation profile 58 (FIG. 2) is disposed on the load bar 40 between the right hand threads 49 and the left hand threads. The load bar 40 supports a load plate 61 as will be described in greater detail herein.

As shown at the bottom of FIG. 2, the load plate 61 may be connected to an underhung hoist by a first clevis 64 and a second clevis 67 through engagement with retaining pins 70 and 73 that are inserted through aligned openings in the first clevis 64, the second clevis 67 and hoist openings 74, 75 in the load plate 61. Other mechanical arrangements for attaching the load plate 61 to a hoist will be evident to persons of ordinary skill in the art based on this disclosure.

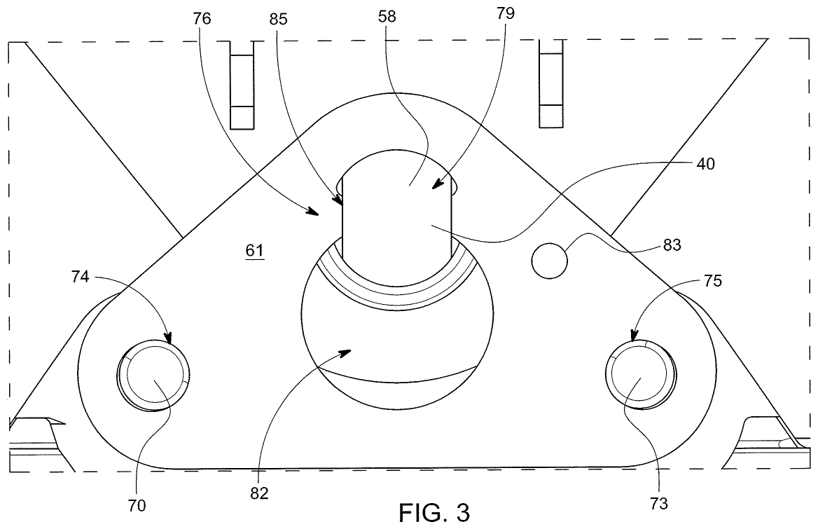

Turning to FIG. 3, a cross-section taken along a midportion of FIG. 2 illustrates the connection of the load plate 61 to the load bar 40. As shown, in one embodiment the load plate 61 may have a generally triangular shape with a central opening 76 having a first portion 79 and a second portion 82. The second portion 82 may be disposed below the first portion 79. The first portion 79 may be provided with an anti-rotation keyway 85 that is configured to engage with the anti-rotation profile 58 disposed in the midportion 55 of the load bar 40. The mating of the profile 58 inside the anti-rotation keyway 85 prevents the load plate 61 from rotating relative to the load bar 40 when the trolley 10 is in use with a hoist traveling along a beam 13.

The second portion 82 is larger than the first portion 79. The second portion 82 may be substantially round in shape. The second portion 82 is configured to allow for rotation of the load bar 40 relative to the load plate 61.

In use, the opposite threads on each end of the load bar 40 are engaged with the threaded openings in the first and second side plates 16 and 19. While the side plates 16 and 19 are prevented from rotating, rotation of the load bar 40 in a first direction causes the first and second plates 16 and 19 to move toward each other. And with the first and second plates 16 and 19 prevented from rotating, rotation of the load bar 40 in a second direction opposite from the first direction causes the first and second plates 16 and 19 to move away from each other. Accordingly, the width of the trolley 10 may be adjusted by rotating the load bar 40 without disassembling the trolley 10.

The width of the trolley 10 may be adjusted by rotating the load bar 40 from one end at a single point.

The load plate 61 may also be provided with a second opening 83 that is smaller than the opening 76 and disposed in spaced apart relation thereto.

Returning to FIG. 2, an elongate, alignment pin 86 may be disposed through the second openings 31, 37 in the first and second side plates 16 and 19 and through the opening 83 in the load plate 40. As an alternative, the alignment pin 86 may be disposed through one of the side plates 16 or 19 and the load plate 40. The alignment pin 86 prevents the side plates 16 and 19 and the load plate 61 from rotating relative to each other and prevents the load bar 40 from rotating.

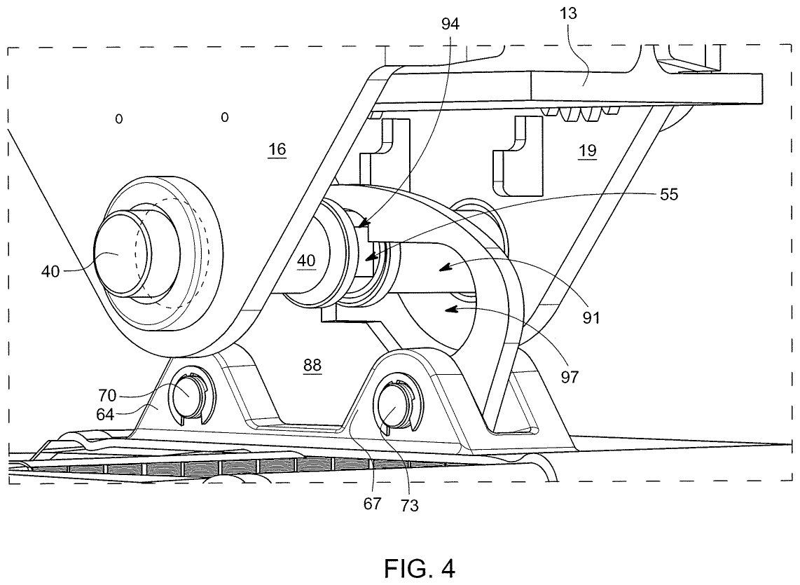

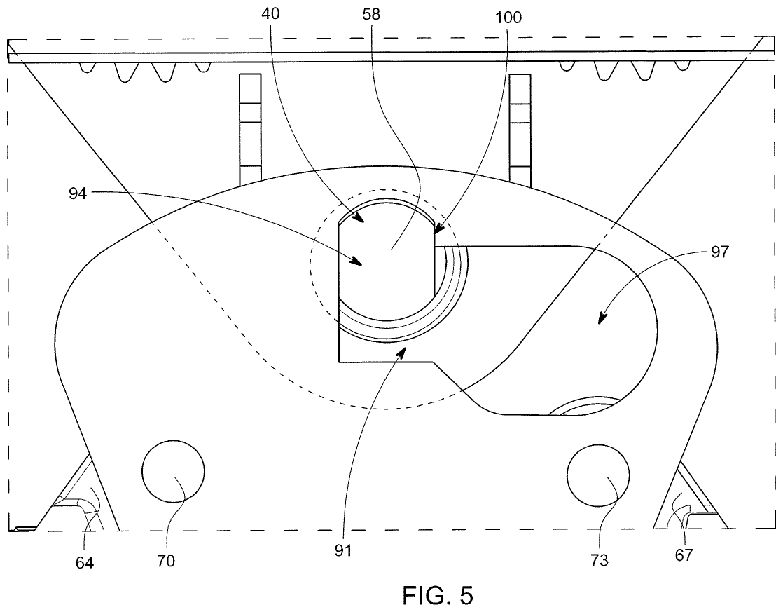

Turning to FIG. 4, in an alternate embodiment, a load plate 88 has an opening 91 with a first portion 94 and a second portion 97. The first portion 94 has an anti-rotation keyway 100 (best shown in FIG. 5) that is configured to engage with the anti-rotation profile 58 at the midportion 55 of the load bar 40. As best shown in FIG. 4, the second portion 97 of the opening is offset laterally from the first portion 94. The second portion 97 is larger than the first portion 94.

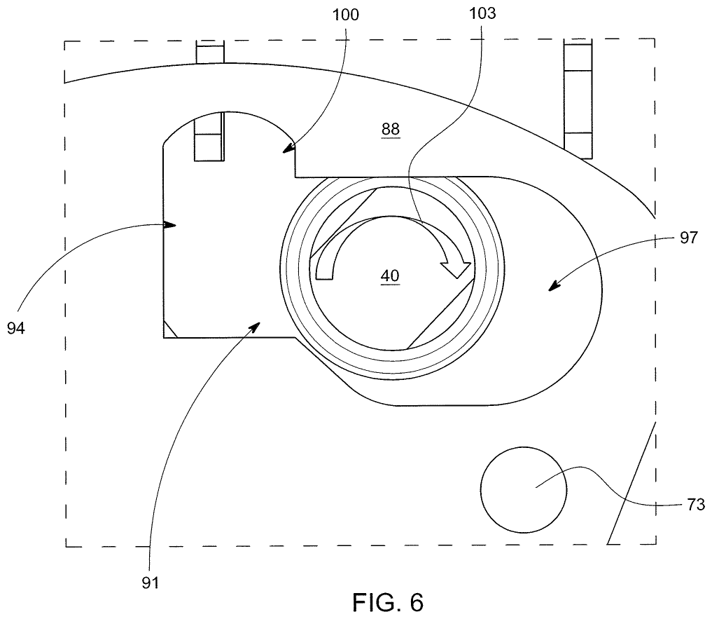

Turning to FIG. 6, the second portion 97 is configured such that the load bar 40 is capable of rotating in the direction of arrow 103 independently of the load plate 88.

In use, the opposite threads on each end of the load bar 40 are engaged with the threaded openings in the first and second side plates 16 and 19. While the side plates 16 and 19 are prevented from rotating, rotation of the load bar 40 in a first direction causes the first and second plates 16 and 19 to move toward each other. And with the first and second plates 16 and 19 prevented from rotating, rotation of the load bar 40 in a second direction opposite from the first direction causes the first and second plates 16 and 19 to move away from each other. Accordingly, the width of the trolley 10 may be adjusted by rotating the load bar 40 without disassembling the trolley 10.

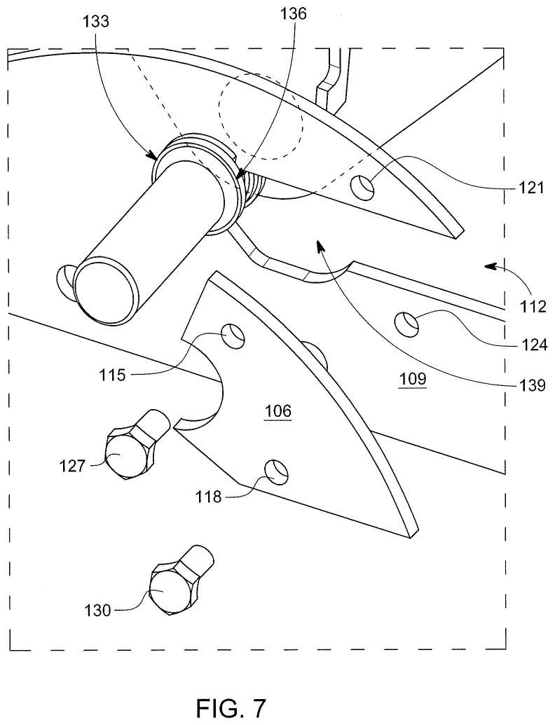

In FIG. 7, an alternate embodiment shows a removable plate 106 configured for attachment to a load plate 109 having an open slot 112 formed on the right side. The removable plate 106 may have a pair of openings 115, 118 configured to align with openings 121, 124 in the load plate 109. A pair of fasteners 127, 130 may be used to removably attach plate 106 to plate 109. Plate 109 has an opening 133 with a first portion 136 having a keyhole shape and having a second portion 139 which is larger than the first portion 136. The second portion 139 extends to the open slot 112 on the right side.

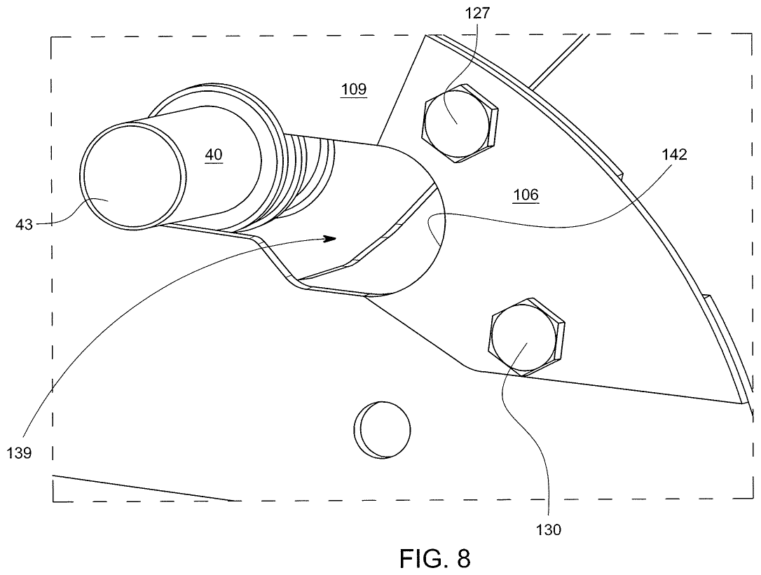

As shown in FIG. 8, when the removable plate 106 is attached to the load plate 109 a curved end 142 is formed at the right hand side of the second portion 136. The removable plate 106 provides for easier installation of the load bar 40.

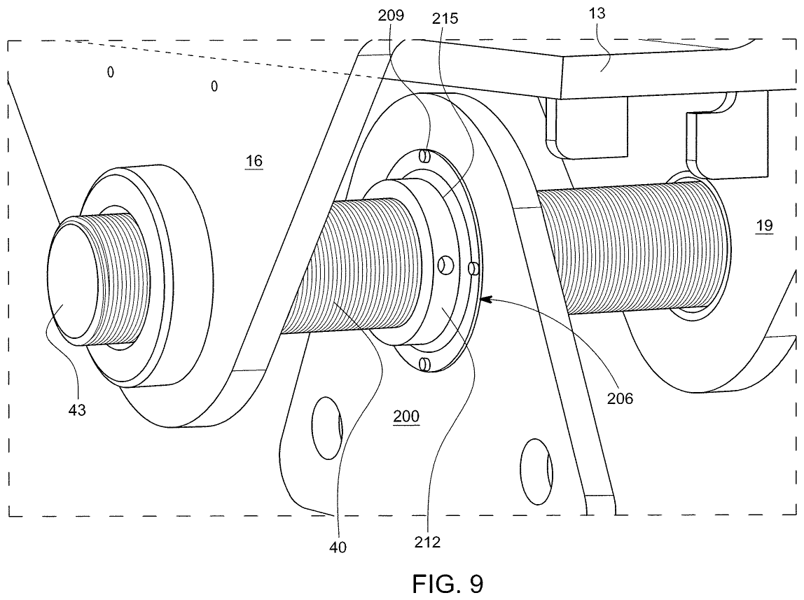

Another embodiment of the invention is shown in FIG. 9. A load plate 200 has a central opening 203 with a bearing 206 installed therein. An outer race 209 of the bearing 206 is permanently fixed to the plate 200. A collar 212 may be permanently fixed an inner race 215 of the bearing 206. The collar 212 may be provided with internal threads that can lock into engagement with the threads on the load bar 40 preventing rotation between the collar 212 and the load bar 40.

Accordingly, the load bar 40 may alternate between a first state allowing for free rotation of the load bar relative to the load plate 200 and a second state where the load bar 40 is prevented from rotating relative to the load plate 200. If the load bar 40 is allowed to rotate with the side plates prevented from rotating then the rotation of the load bar in a first direction cause the side plates to move inward simultaneously and rotation of the load bar in a second direction opposite the first direction causes the side plates to move outward simultaneously. During operation of the hoist, the collar 212 is locked down on the load bar 40 and the inner and outer race of the bearing are locked together and there is no rotational movement between the load bar and the side plates.

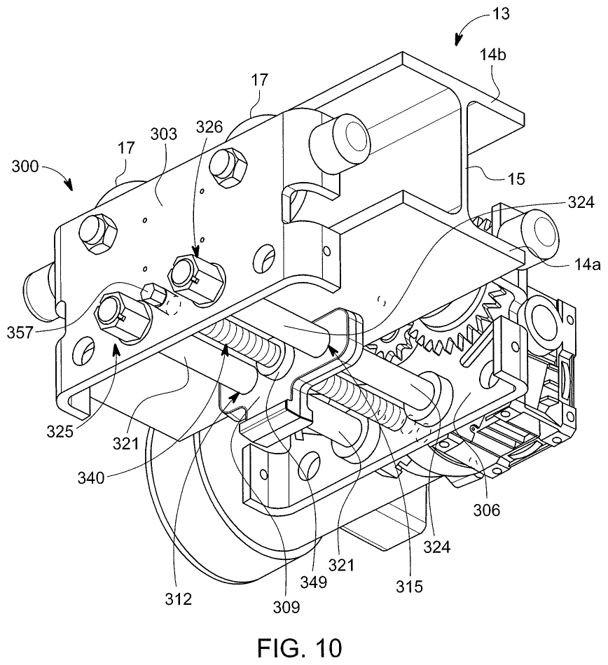

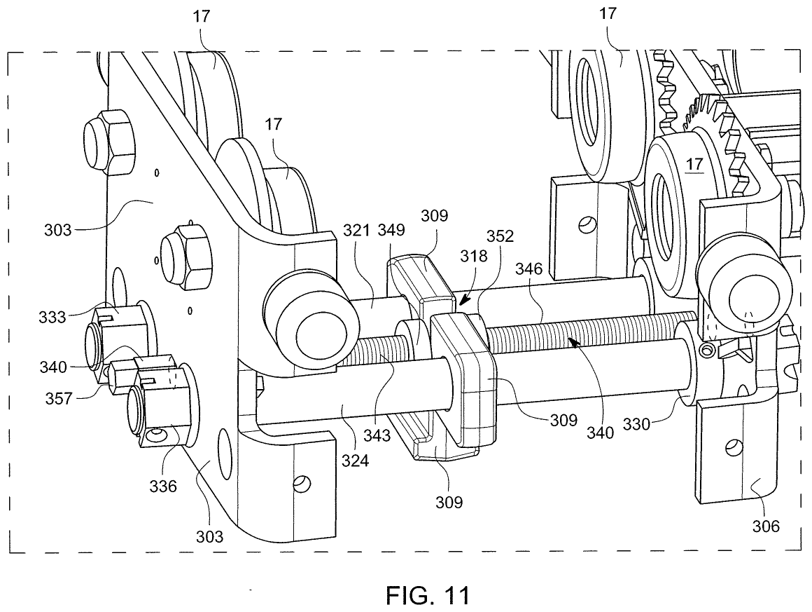

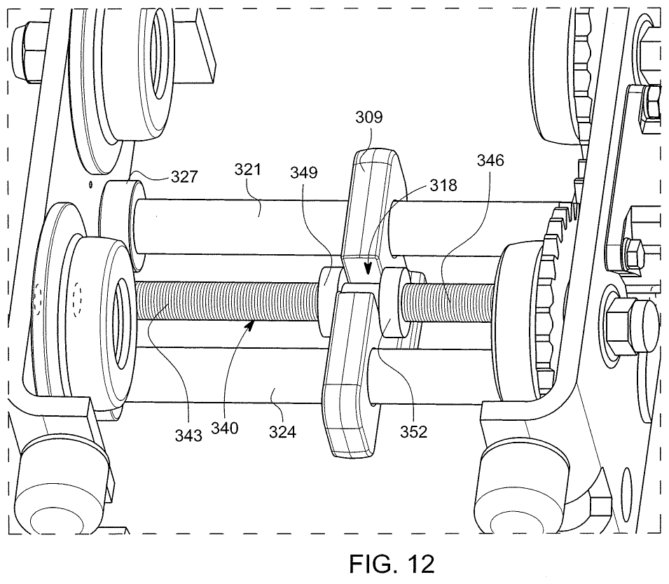

Turning to FIG. 10, another embodiment of the invention allows the hoist to be closer to the trolley 300 for increased headroom. The trolley 300 has wheels 17 that mount on side plates 303 and 306. A load plate 309 has two openings 312, 315 defined therein and a slot 318 (FIGS. 11-12) disposed between the openings 312, 315.

A pair of load bars 321, 324 may be disposed in spaced apart parallel relation. The load bars 321, 324 extend through openings 325, 326 in the side plates 303, 306 and through openings 312, 315 in the load plate 309. The load bars 321, 324 may comprise cylindrical-shaped solid members having threaded sections along a portion near the opposite ends. The threaded sections are configured to receive fasteners 333 and 336. The side plates 303, 306 are configured to slide inward and outward relative to the load bars 321, 324. Collars 327, 330 having a central opening may be positioned on the load bars 321, 324.

Turning to FIG. 11, a cylindrical rod 340 may be provided with right hand threads 343 and left hand threads 346 on opposite sides of the slot 318. A first enlarged portion 349 which may be in the shape of an enlarged diameter section resembling a collar and a second enlarged portion 352 which may also be an enlarged diameter section in the shape of a collar are disposed on opposite sides of the slot 318. The first and second enlarged portions 349, 352 prevent the rod 340 from translatory motion but allow the rod 340 to rotate. The side frames 303, 306 have threaded openings 350, 353 configured to engage with the threads 343, 346 on the rod 340. Rotation of the rod 340 from a single point (that may be provided with a hex head 357 for engaging with a tool as shown in FIG. 11) in a first direction cause the side frames 303, 306 to move inward and rotation of the rod 340 in a second direction causes the side frames 303, 306 to move outward. Accordingly the width of the trolley 300 may be adjusted from a single point without disassembling the trolley 300.

In use the width of the trolley 300 is adjusted by turning the rod 340 until the position of the side plates 303, 306 is set for the width of the beam that the trolley 300 is being used with. In order to fix the position of the side plates 303, 306, the fasteners 325, 326 and the collars 327 and 330 are then fixed in position on the load bars 321, 324.

The present invention contemplates that many changes and modifications may be made. Therefore, while the presently-preferred form of the trolley single point adjustment system has been shown and described, and several modifications and alternatives discussed, persons skilled in this art will readily appreciate that various additional changes and modifications may be made without departing from the spirit of the invention, as defined and differentiated by the following claims.

1. A trolley for use on a beam, the trolley having a width adjustment system, the trolley comprising:
a first side plate having two or more wheels disposed thereon, the first side plate configured to couple with the beam, the first side plate having an opening with threads disposed therein;
a second side plate having two or more wheels disposed thereon, the second side plate configured to couple with the beam, the second side plate having an opening with threads disposed therein;
a load bar having a first end disposed opposite from a second end, the load bar having right hand threads extending in the longitudinal direction toward the first end and a left hand threads extending in the longitudinal direction toward the second end, the load bar having an anti-rotation profile in cross-section along a midportion between the right and left hand threads;
a load plate having an opening defined therein, the opening having a first portion defining an anti-rotation keyway configured to receive the anti-rotation profile on the load bar to prevent relative rotation between the load bar and the load plate and the opening having a second portion that is larger than the first portion, the second portion is configured to allow the load bar to rotate independently of the load plate;
wherein rotation of the load bar from one end while the load bar is disposed in the second portion of the opening in the load plate causes the first side plate and second side plate to move toward each other to adjust the width of the beam trolley.

2. The trolley set forth in claim 1, wherein the load plate has a second opening configured to receive a pin.

3. The trolley set forth in claim 2, wherein the first and second side plates have second openings configured to receive the pin.

4. The trolley set forth in claim 3, wherein the pin extends through the second opening in the first plate and the second opening in the load plate.

5. The trolley set forth in claim 3, wherein the pin extends through the second opening in the first plate, the second opening in the second plate, and the second opening in the load plate.

6. The trolley set forth in claim 1, further comprising a jam nut disposed on the load bar.

7. The trolley set forth in claim 1, wherein the first portion of the opening in the load plate is disposed above the second portion of the opening in the load plate.

8. The trolley set forth in claim 1, wherein the second portion of the opening in the load plate is offset laterally from the first portion of the opening in the load plate.

9. The trolley set forth in claim 8, wherein the second portion of the opening in the load plate extends lengthwise through a side of the load plate to form a slot having an opening at the end.

10. The system set forth in claim 9, further comprising a removable plate configured to attach to the load plate to close the opening at the side of the load plate.

11. A trolley for use on a beam, the trolley having a width adjustment system, the trolley comprising:
a first side plate having two or more wheels disposed thereon, the first side plate configured to couple with the beam, the first side plate having an opening with threads disposed therein;
a second side plate having two or more wheels disposed thereon, the second side plate configured to couple with the beam, the second side plate having an opening with threads disposed therein;
a load bar having a first end disposed opposite from a second end, the load bar having right hand threads extending in the longitudinal direction toward the first end and a left hand threads extending in the longitudinal direction toward the second end;
a load plate having an opening defined therein, the opening having a bearing disposed therein, the bearing operatively associated with the load bar such that in a first configuration the load bar rotates freely relative to the load plate and in a second configuration the load bar is prevented from rotating relative to the load plate;
wherein rotation of the load bar while the side plates are prevented from rotating causes the first side plate and second side plate to move toward each other to adjust the width of the trolley.

12. A trolley for use on a beam, the trolley having a width adjustment system, the trolley comprising:
a first side plate having two or more wheels disposed thereon, the first side plate configured to couple with the beam, the first side plate having an opening with threads disposed therein;
a second side plate having two or more wheels disposed thereon, the second side plate configured to couple with the beam, the second side plate having an opening with threads disposed therein;
an elongate rod having a first end disposed opposite from a second end, the elongate rod having right hand threads extending in the longitudinal direction toward the first end and a left hand threads extending in the longitudinal direction toward the second end, the right hand threads and left hand threads on the elongate rod configured to engage with the threads in the openings on the first and second side plates;
a pair of load bars extending between the side plates and supported therefrom;
a load plate having a pair of openings defined therein, the openings configured to receive the load bars, the load plate having a third opening for receiving the elongate rod;
wherein rotation of the elongate rod in a first direction while the side plates are prevented from rotating causes the first side plate and second side plate to move toward each other to adjust the width of the trolley.

13. The trolley of claim 12, wherein the third opening in the load plate comprises an open slot.

14. The trolley of claim 13, wherein the elongate rod further comprises enlarged portions disposed on opposite sides of the slot when the elongate rod is disposed on the load plate.

15. The trolley of claim 12, wherein the elongate rod has a head at one end configured to receive a tool for turning the elongate rod.

16. The trolley of claim 12, further comprising collars removably attached to the load bars.

17. The trolley of claim 12, further comprising fasteners configured to engage with opposite ends of the load bars.

18. The trolley of claim 13, wherein the open slot faces upward when the trolley is installed on the beam.
